(19) United States
(12) Patent Application Publication
(10) Pub. No.: US 2007/0220855 A1
(43) Pub. Date: Sep. 27, 2007

(54) Manufacturing method of plugged honeycomb structure and plugged honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/716,610

(22) Filed: Mar. 12, 2007

(30) Foreign Application Priority Data
Mar. 23, 2006 (JP) 2006-080450
Feb. 14, 2007 (JP) 2007-033873

(51) Int. Cl. B01D 46/00

(52) U.S. Cl. 55/523

(57) ABSTRACT

There is disclosed a manufacturing method of a plugged honeycomb structure, capable of inexpensively manufacturing the plugged honeycomb structure which does not have any defect in a short time without any restriction on an operation environment and capable of reducing an amount of industrial wastes. A mask 30 for forming plugging portions is prepared based on image data of an end surface of a honeycomb structure 2 by an optical forming process, the mask having pores 33 capable of communicating with cells 19a to be plugged and convex portions 35 capable of fitting into cells 19b which are not to be plugged. After fixing the mask to the end surface of the honeycomb structure 2, the honeycomb structure 2 to which the plugging portion forming mask 30 is fixed is set in a vessel 20 having, in an upper portion, an opening into which the plugging portion forming mask 30 can fit and containing a slurry 50 for plugging, and opening ends of the cells 19a to be plugged are filled with the slurry 50 for plugging through the pores 33 of the plugging portion forming mask 30 to thereby form the plugging portions.

### BACKGROUND OF THE INVENTION

1. Field of the Invention

The present invention relates to a plugged honeycomb structure for use as a filter such as a diesel particulate filter which filtrate particulate matters, a catalyst carrier in which a catalyst component is carried by pore surfaces of porous partition walls to form divided cells and in which an exhaust gas is passed through pores of the partition walls to thereby purify poisonous exhaust gas components such as HC, NOₓ and CO and the like.

2. Description of the Related Art

An exhaust gas discharged from an internal engine such as a diesel engine contains a large amount of particulates (particulate matters) mainly containing carbon which is likely to be a cause for environmental pollutions. Therefore, a filter for trapping (filtering) the particulates is generally mounted on an exhaust system of the engine.

In the filter for use in such a purpose, a plugged honeycomb structure 1 is usually used. As shown in FIGS. 16(a) and 16(b), the structure includes a honeycomb structure 2 where a plurality of cells 9 which communicate between two end surfaces of the honeycomb structure are divided by porous partition walls 7; and plugging portions 11 arranged in checkered patterns complementary to each other at one end surface and the other end surface of the honeycomb structure 2 so as to plug one of two opening ends of each cell 9.

The exhaust gas enters such a filter constituted of the plugged honeycomb structure 1 from one end surface 3. After the particulates contained in the gas and the like are removed, the gas is discharged from the other end surface 5. Specifically, first the exhaust gas enters cells 9b including end portions which are not plugged at the one end surface 3 of this filter and including plugged end portions at the other end surface 5. The gas passes through the porous partition walls 7, moves to cells 9a including plugged end portions at the one end surface 3 and including end portions which are not plugged at the other end surface 5, and is discharged from these cells 9a. Moreover, at this time, the partition walls 7 function as filter layers, and the particulates contained in the gas are trapped by the partition walls 7 and deposited on the partition walls 7.

As a manufacturing method of the above plugged honeycomb structure, a method is disclosed in which an adhesive sheet or the like is attached to one end surface of a formed honeycomb body. Pores are made at only portions corresponding to cells (plugged cells) of the adhesive sheet or the like to be plugged by laser processing or the like using image processing to obtain a mask. The end surface of the formed honeycomb body to which the mask is attached is immersed into a slurry for plugging. The cells of the formed honeycomb body to be plugged are filled with the slurry to form plugging portions. The other end surface of the formed honeycomb body is also subjected to steps similar to the above steps. Subsequently, the body is dried and fired to thereby obtain the plugged honeycomb structure (see, e.g., Patent Document 1).

Moreover, as another manufacturing method, a method is proposed in which through holes are formed into a checkered pattern (a zigzag pattern) in a non-dried formed sheet-like body formed of a ceramic material, and this formed sheet-like body is attached under pressure to an end surface of a dried honeycomb-like body, and integrally fired to thereby obtain the plugged honeycomb structure (see, e.g., Patent Document 2).

[Patent Document 1] Japanese Patent Application Laid-Open No. 2001-300922; and

[Patent Document 2] Japanese Patent Application Laid-Open No. 2002-159811.

Additionally, in recent years, an attempt is also made to use such a plugged honeycomb structure as not only the above filter for filtering the particulate substances but also a catalyst carrier. In the carrier of a catalyst (such a catalyst will hereinafter be referred to as the “wall flow type catalyst”), a catalyst component is carried by pore surfaces of porous partition walls which form divided cells, and an exhaust gas entering the honeycomb structure is passed through pores of the partition walls to thereby purify poisonous exhaust gas components such as HC, NOₓ and CO.

With enlargement of an application of such a plugged honeycomb structure, it is expected that a demand for the plugged honeycomb structure further increases in future. In a case where the plugged honeycomb structure is mass-produced by use of the manufacturing method described in Patent Document 1, it has been necessary to solve the problems: (i) the opposite end surfaces of each honeycomb structure need to be subjected to all steps of attaching the adhesive sheet, processing an image, making pores and peeling the adhesive sheet, much time is required in preparation of the mask and the like, and additionally the adhesive sheet peeled after used forms a large amount of industrial wastes; and (ii) the adhesive sheet is comparatively expensive, is a cause for a production cost rise and needs to be attached in a clean environment in order to avoid dust and trash, and there is a restriction on an operation environment. That is, the above conventional manufacturing method is an effective method for manufacturing a comparatively small amount of plugged honeycomb structures, but cannot be said to be a sufficiently satisfactory method from a viewpoint of adaptability to mass production.

Moreover, in the above manufacturing method described in Patent Document 2, sheets are easily cracked and peeled owing to a dry shrinkage difference between the dried honeycomb-like body and the non-dried formed sheet-like body. There has also been a problem that among the cells positioned at an outermost periphery of the honeycomb structure, the cells to be plugged are not easily plugged.

### SUMMARY OF THE INVENTION

The present invention has been developed in view of the above problem of the conventional technology, and an object of the present invention is to provide a manufacturing method of a plugged honeycomb structure, which is suitable for mass production. More specifically, the present invention is directed to a manufacturing method of a plugged honeycomb structure, capable of inexpensively manufacturing the plugged honeycomb structure which does not have any defect in a short time without any restriction on an operation environment and capable of reducing an amount of industrial wastes.

To achieve the above object, according to the present invention, the following manufacturing method of a plugged honeycomb structure and the following plugged honeycomb structure are provided.

[1] A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell, the method comprising: photographing the end surface of the honeycomb structure to acquire image data which specifies shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged; fitting the convex portions into the cells which are not to be plugged to thereby fix the mask for forming the plugging portions to the end surface of the honeycomb structure; then fitting the mask for forming the plugging portions into an opening of a vessel to thereby set the honeycomb structure to which the mask for forming the plugging portions is fixed in the vessel having, in an upper portion, the opening into which the mask for forming the plugging portions fits and containing a plugging slurry obtained by forming a material of the plugging portions into a slurry; and filling opening ends of the cells to be plugged with the slurry for plugging contained in the vessel through the pores of the mask for forming the plugging portions to thereby form the plugging portions.

[2] A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell, the method comprising: photographing the end surface of the honeycomb structure to acquire image data which specifies shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged; fitting the mask for forming the plugging portions into an opening of a vessel to thereby set the mask in the vessel having, in an upper portion, the opening into which the mask for forming the plugging portions fits and containing a plugging slurry obtained by forming a material of the plugging portions into a slurry; then fixing the end surface of the honeycomb structure to the mask for forming the plugging portions so that the convex portions of the mask for forming the plugging portions fit into the cells which are not to be plugged; and filling opening ends of the cells to be plugged with the slurry for plugging contained in the vessel through the pores of the mask for forming the plugging portions to thereby form the plugging portions.

[3] A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell, the method comprising: photographing the end surface of the honeycomb structure to acquire image data which specifies shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged; fitting the convex portions into the cells which are not to be plugged to thereby fix the mask for forming the plugging portions to the end surface of the honeycomb structure; immersing the end surface of the honeycomb structure to which the mask for forming the plugging portions is fixed into a plugging slurry obtained by forming a material of the plugging portions into a slurry and contained in a vessel; and filling opening ends of the cells to be plugged with the slurry for plugging through the pores of the mask for forming the plugging portions to thereby form the plugging portions.

[4] The manufacturing method of the plugged honeycomb structure according to the above [1] or [3], wherein the mask for forming the plugging portions is fixed beforehand to a mask support member having a structure including a large number of pores, and then fixed to the end surface of the honeycomb structure.

[5] The manufacturing method of the plugged honeycomb structure according to the above [2], wherein the mask for forming the plugging portions is fixed beforehand to a mask support member having a structure including a large number of pores, and then set in the vessel.

[6] The manufacturing method of the plugged honeycomb structure according to any one of the above [1] to [5], wherein the convex portions have a shape tapered toward a tip end.

[7] The manufacturing method of the plugged honeycomb structure according to the above [6], wherein an outer diameter of a maximum outer diameter portion of the convex portion as a part of the convex portions is larger than an inner dimension of the cell into which the convex portion fits.

[8] The manufacturing method of the plugged honeycomb structure according to any one of the above [1] to [7], wherein among the convex portions, an outer diameter of the convex portion fitted into the cell positioned at an outermost periphery of the honeycomb structure and having a shape different from that of the cell disposed inwardly from the cell is smaller than that of the other convex portion.

[9] A plugged honeycomb structure comprising: a honeycomb structure where a plurality of cells which communicate between two end surfaces of the honeycomb structure are divided by porous partition walls; and plugging portions arranged so as to plug one of two opening ends of each cell, wherein the cells to be plugged among the cells positioned at an outermost periphery of the honeycomb structure are securely plugged with the plugging portions.

[10] The plugged honeycomb structure according to the above [9], which is manufactured by the manufacturing method according to any one of the above [1] to [8].

[11] The plugged honeycomb structure according to the above [10], wherein an outer peripheral portion is provided with a protrusion or a groove as a reference of positioning during the fixing of the mask for forming the plugging portions to the end surface of the honeycomb structure.

[12] The plugged honeycomb structure according to any one of the above [9] to [11], wherein the cells are plugged with the plugging portions at only one end surface of the honeycomb structure.

The manufacturing method of the plugged honeycomb structure according to the present invention is a method capable of inexpensively manufacturing the plugged honeycomb structure which does not have any defect in a short time without any restriction on an operation environment and capable of reducing an amount of industrial wastes. The method is suitable for mass production. The mask for forming the plugging portions is prepared based on the actual image data of the honeycomb structure. Therefore, even in a case where the honeycomb structure having a shape as designed cannot be obtained owing to deformation and the like during the forming, the mask adapted to the shape and having a shape precision can be prepared. Therefore, the honeycomb structure having a high cell density (a large number of cells) can be provided with the plugging portions in correct positions without any deviation. Furthermore, in the plugged honeycomb structure manufactured by a conventional manufacturing method in which a non-dried formed sheet-like body provided with through holes formed in a checkered pattern is attached under pressure to the end surface of a dried honeycomb-like body and integrally fired, the cells positioned at an outermost periphery are not easily plugged. However, according to the plugged honeycomb structure of the present invention, the cells to be plugged are securely plugged with the plugging portions, even when the cells are positioned at the outermost periphery. In consequence, the plugged honeycomb structure exhibits a high performance, when the structure is used as a filter or a carrier for a wall flow type catalyst.

### BRIEF DESCRIPTION OF THE DRAWINGS

FIG. 1 is a schematic diagram showing one example of an embodiment of a manufacturing method according to the present invention;

FIG. 2 is a schematic diagram showing one example of the embodiment of the manufacturing method according to the present invention;

FIG. 3 is a schematic diagram showing one example of the embodiment of the manufacturing method according to the present invention;

FIG. 4 is a schematic diagram showing one example of the embodiment of the manufacturing method according to the present invention;

FIG. 5 is a schematic diagram showing one example of the embodiment of the manufacturing method according to the present invention;

FIG. 6 is a schematic diagram showing another example of the embodiment of the manufacturing method according to the present invention;

FIG. 7 is a schematic diagram showing still another example of the embodiment of the manufacturing method according to the present invention;

FIG. 8 is a schematic diagram showing an embodiment of a mask for forming plugging portions for use in the manufacturing method of the present invention;

FIG. 9 is a schematic diagram showing the embodiment of the mask for forming the plugging portions for use in the manufacturing method of the present invention;

FIG. 10(a)(b) are schematic diagrams showing a structure of a mask support member, FIG. 10(a) is a plan view, and FIG. 10(b) is a sectional view;

FIG. 11 is a schematic diagram showing an example in which the mask for forming the plugging portions is fixed beforehand to the mask support member, and then fixed to an end surface of a honeycomb structure;

FIG. 12 is a schematic diagram showing an example in which the mask for forming the plugging portions is fixed beforehand to the mask support member, and then set in a vessel;

FIG. 13 is a schematic diagram showing a part of a plugged honeycomb structure according to the present invention;

FIG. 14 is a schematic diagram showing a part of a conventional plugged honeycomb structure;

FIG. 15 is a schematic diagram showing one example of an embodiment of the plugged honeycomb structure according to the present invention; and

FIGS. 16(a)(b) are schematic diagrams showing a basic structure of the plugged honeycomb structure, FIG. 16(a) is a plan view viewed from one end surface side, and FIG. 16(b) is a sectional view.

### DESCRIPTION OF THE PREFERRED EMBODIMENT

A typical embodiment of the present invention will hereinafter be described specifically, but it should be understood that the present invention is not restricted by the following embodiment, and a change of design, improvement and the like are appropriately added based on ordinary knowledge of any person skilled in the art without departing from the scope of the present invention. It is to be noted that in the present specification, a “honeycomb structure” simply mentioned means a honeycomb structure which does not have any plugging portion.

In a manufacturing method of a plugged honeycomb structure of the present invention, to dispose plugging portions on the honeycomb structure, a mask for forming the plugging portions is prepared. The mask has pores capable of communicating with cells to be plugged and convex portions capable of fitting into cells which are not to be plugged. The mask is used in disposing the plugging portions on the honeycomb structure. To prepare this mask for forming the plugging portions, first an end surface of the honeycomb structure is photographed to acquire image data capable of specifying shapes and positions of the cells to be plugged and the cells which are not to be plugged in the end surface.

Since the honeycomb structure is usually manufactured by extruding a ceramic clay, cell shapes, partition wall thicknesses, cell densities and the like are not uniform, and distortions are sometimes generated. However, in a case where the end surface of the honeycomb structure is photographed and the image data capable of specifying the shapes and the positions of the cells to be plugged and the cells which are not to be plugged is acquired, the mask for forming the plugging portions adapted to the honeycomb structure can be prepared.

The mask will more specifically be described. The convex portions of the mask for forming the plugging portions can be formed into appropriate portions at correct positions. Therefore, the convex portions can easily be fitted into the cells of the honeycomb structure which are not to be plugged, and the mask for forming the plugging portions can securely be fixed to the end surface of the honeycomb structure. It is to be noted that since the convex portion is formed into a tapered tip end shape, the convex portion easily enters the cell, and is more easily fitted into the cell. In this case, an outer diameter of a maximum outer diameter portion (the vicinity of a bottom portion of the convex portion) of the convex portion as a part of the plurality of convex portions is set to be larger than an inner dimension of each cell to which the convex portion is to be plugged. In consequence, the mask for forming the plugging portions can more securely be fixed to the end surface of the honeycomb structure. Since the pores of the mask for forming the plugging portions can similarly be formed into appropriate shapes at correct positions, a slurry for plugging can securely be introduced into an end of each cell to be plugged in the honeycomb structure, and the plugging portions can correctly be formed at the cells to be plugged.

Since the cells positioned at an outermost periphery of the honeycomb structure usually come into contact with an outer wall, the cells have shapes different from those of the other cells positioned inwardly from the cells. Specifically, a part of the cell has a shape extended along an inner surface of the outer wall, and an opening area of the cell is smaller than that of the other cell. At such a cell (hereinafter referred to as the “partial cell”) positioned at the outermost periphery of the honeycomb structure and having the shape different from that of the other cell positioned inwardly from the cell, the plugging portion is not easily formed as compared with the other cell. The plugging portion cannot be formed at the cell in some case. In a known technology for solving this problem, after performing a step of forming the plugging portions, the outer wall is processed and removed to expose the partial cells, and the partial cells are coated with a ceramic coating material to fill in the partial cells. Moreover, the outer wall is formed again.

When the partial cells are finally filled with the ceramic coating material and integrated with the outer wall in this manner, the partial cells do not have to be necessarily plugged. Therefore, the convex portions which fit into the partial cells are not necessary. However, in another case, the convex portions which fit into the partial cells are required. Here, it is preferable that an outer diameter of the convex portion which fits into the partial cell is set to be smaller than that of the other convex portion which fits into the cell other than the partial cell. This is because the convex portion easily enters even the partial cell having a small opening area, and the convex portion can securely be fitted into and fixed to the cell.

It is to be noted that the end surface of each honeycomb structure does not have to be necessarily photographed. As described above, the honeycomb structure is usually manufactured by extruding the ceramic clay. Therefore, degrees of the distortions of the cell shapes, the partition wall thicknesses, the cell densities and the like are basically similar as long as the honeycomb structures have the same composition of the ceramic clay and the same conditions during kneading, extruding and the like. That is, when the image data is once acquired from one honeycomb structure of a lot having the same conditions, the mask for forming the plugging portions prepared based on the image data can be used in the other honeycomb structure (i.e., the mask for forming the plugging portions can be reused). In consequence, the manufacturing method of the present invention is suitable for mass production.

There is not any special restriction on an image pickup device for photographing the end surface of the honeycomb structure, but, for example, a charge-coupled device (CCD) camera, an X-ray computed tomography (CT) scanner or the like is preferably usable. Above all, the X-ray CT scanner can photograph not only the end surface of the honeycomb structure but also the inside (an inner shape of the cell or the like) of the honeycomb structure. Therefore, the scanner is preferable in that it is possible to prepare the mask for forming the plugging portions suitable for the honeycomb structure. Since a tomographic configuration of the honeycomb structure can directly be photographed, there is an advantage that tomographic configuration data (slice data) of the mask for forming the plugging portions required for an optical forming process is easily prepared.

Based on the image data acquired as described above, the mask for forming the plugging portions, having the pores capable of communicating with the cells of the honeycomb structure to be plugged and the convex portions capable of fitting into the cells which are not to be plugged, is prepared by the optical forming process.

Here, the optical forming process is a method in which an operation of irradiating the surface of a non-set photo-setting component composition with light in an imaging manner to form a set resin layer and similarly forming and laminating a new set resin layer on an upper surface of the set resin layer is repeated to obtain a three-dimensionally formed object constituted of a photo-setting resin composition. The method has an advantage that it is possible to easily and quickly obtain the formed object having a complicated three-dimensional shape. It has been difficult to prepare such a formed object by a conventional forming process such as molding or extruding. Therefore, the method of preparing the mask for forming the plugging portions by the optical forming process as described above has an advantage that even the plugging portion forming mask having the complicated three-dimensional shape (e.g., the cell shape, the partition wall thickness, the cell density and the like are not uniform and are sometimes distorted) can easily and quickly be obtained. Moreover, the shape can easily be changed. It is to be noted that to prepare a thin plugging portion forming mask, the mask can sometimes be prepared by forming only one set resin layer.

The “mask for forming the plugging portions” mentioned in the present specification is a mask having the pores capable of communicating with the cells of the honeycomb structure to be plugged and convex portions capable of fitting into the cells of the honeycomb structure which are not to be plugged and constituted of the photo-setting resin composition. As long as the above conditions are satisfied, there is not any special restriction on the whole shape of the mask for forming the plugging portions. However, a plugging portion forming mask 30 shown in FIG. 8 can preferably be used in which a plate-like mask main body 31 having an area capable of covering the end surface of the honeycomb structure is provided with pores 33 and convex portions 35.

The pores 33 are formed so as to communicate with the cells of the honeycomb structure to be plugged. When the slurry for plugging is introduced into ends of the cells of the honeycomb structure to be plugged through the pores, the plugging portions can be formed at the cells of the honeycomb structure to be plugged.

Each pore 33 does not necessarily have to have a shape which completely matches that of the cell to be plugged as long as the slurry for plugging can be introduced into the cell of the honeycomb structure to be plugged, and there is not any special restriction on the shape of the pore. For example, when the cell of the honeycomb structure has a quadrangular shape, the pore may have a circular shape.

Moreover, there is not any special restriction on an open pore area of each pore as long as the slurry for plugging can be introduced into the cells of the honeycomb structure to be plugged. The area may appropriately be set in accordance with viscosity (ease of introduction into the cell) of the plugging slurry to be introduced.

Each convex portion 35 is formed into a shape capable of fitting into the cell of the honeycomb structure which is not to be plugged. In a case where this convex portion is fitted into the cell which is not to be plugged, the mask for forming the plugging portions can be fixed to the end surface of the honeycomb structure.

A “photo-setting component” mentioned in the present specification is an oligomer, a monomer or the like (a so-called prepolymer) having, in a molecule, one or more functional groups capable of reacting with light irradiation to form a crosslinking structure. Needless to say, a mixture of a plurality of prepolymers is included.

Examples of the oligomer include oligomers of radical polymerization type photo-setting resins such as an unsaturated polyester-based resin, an acrylic resin and en-thiol-based resin; and cationic polymerization type photo-setting resins such as an epoxy-based resin. Examples of the monomer include radical polymerization monomers such as acrylates and methacrylates; and cationic polymerization monomers such as epoxy-containing compounds. It is to be noted that the “photo-setting component composition” mentioned in the present specification is a composition containing the above photo-setting component as a constituent component.

Examples of a method of preparing the above mask for forming the plugging portions based on the acquired image data by the optical forming process include the following method.

First, the end surface of the honeycomb structure is photographed with a CCD camera, and data of a surface image is acquired. Subsequently, the surface image data is binarized to thereby specify the shapes and the positions of the cells to be plugged and the cells which are not to be plugged. Moreover, three-dimensional configuration data of the mask for forming the plugging portions is prepared so that the convex portions and the pores are formed into appropriate shapes at correct positions of the honeycomb structure.

In addition, the image pickup device is not limited to the CCD camera, and the X-ray CT scanner may be used. Specifically, even in a case where the honeycomb structure (a portion other than the end surface, e.g., an inner shape, of the cell, etc.) is photographed with the X-ray CT scanner to acquire data of a tomographic image including a surface image of the structure and the tomographic image data is binarized, the shapes and the position of the cells to be plugged and the cells which are not to be plugged can be specified, and the three-dimensional configuration data of the mask for forming the plugging portions can be prepared.

It is to be noted that “binarization” mentioned in the present specification is a treatment to divide the image data into 256 gradation colors and convert the data into a binary monochromatic image so that a portion having a luminance higher than a threshold value as a boundary is white and a portion having a luminance lower than the value is black. In consequence, it is possible to distinguish between a partition wall portion (black) and a cell portion (white) of the honeycomb structure.

The above three-dimensional configuration data is converted into computer-aided design (CAD) data to form, from the CAD data, the tomographic configuration data (the slice data) constituted by dividing the three-dimensional configuration of the mask for forming the plugging portions into a large number of layers. The surface of the non-set photo-setting component composition is irradiated with the light in the imaging manner in accordance with the slice data to thereby form a set resin layer having a tomographic configuration of the composition. Only one layer of the non-set photo-setting component composition is additionally supplied to the upper surface of this set resin layer, and the surface of the layer is again irradiated with the light in the imaging manner to thereby form and laminate a new set resin layer continued from the previously formed set resin layer. This operation is repeated a predetermined number of times to thereby prepare the plugging portion forming mask constituted of the photo-setting resin composition. It is to be noted that usually in the plugged honeycomb structure, one opening end portion and the other opening end portion of a large number of cells need to be alternately plugged. Therefore, it is to be noted that the masks for forming the plugging portions need to be prepared for the respective end surfaces.

As the light with which the surface of the composition is irradiated to set a photo-setting component, light such as an ultraviolet ray or a visible ray including a peculiar wavelength capable of setting the photo-setting component for use needs to be used. Especially, the ultraviolet ray is preferably usable. Therefore, as an optical irradiation unit, ultraviolet laser or the like that can be subjected to numerical control (NC) is preferably usable. At present, an optical forming device (e.g., SLA7000 (trade name: manufactured by INCS INC.) or the like)) is commercially available. In addition to such an optical irradiation unit, the device includes a supply unit which supplies the photo-setting component, a storage tank in which the photo-setting component is stored, a lifting unit capable of lifting up and down each set resin layer formed by the light irradiation and the like. According to the manufacturing method of the present invention, the mask for forming the plugging portions can more easily and quickly be prepared using such a commercially available optical forming device.

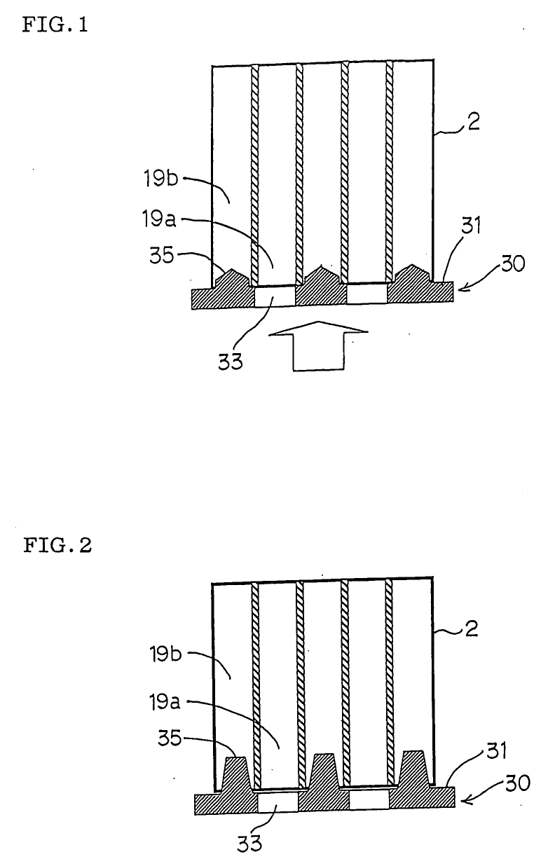

According to the manufacturing method of the present invention, as shown in FIG. 1, first, convex portions 35 of a plugging portion forming mask 30 prepared as described above are fitted into cells 19b which are not to be plugged to thereby fix the plugging portion forming mask 30 to an end surface of a honeycomb structure 2. As shown in FIG. 1, it is preferable that each convex portion 35 has such a tapered tip end shape as to easily fit into the cell 19b which is not to be plugged. It is to be noted that in FIG. 1, the convex portion 35 has a mountain-like shape continued from a straight portion extending from a bottom surface of the plugging portion forming mask 30 (the surface on a side provided with the convex portions 35) in a vertical direction, but the convex portion 35 is not limited to such a shape. For example, as shown in FIG. 2, the convex portion 35 may be formed into such a trapezoidal shape that is gently tapered.

Moreover, as shown in FIG. 9, an right-angled or curved face is formed on a corner portion 39 between the bottom surface of the plugging portion forming mask 30 and the convex portion 35. In consequence, when the convex portion 35 is fitted into the cell 19b, the corner portion 39 comes into contact with a partition wall of the honeycomb structure 2, and sealability of each plugging portion is easily secured. In this case, it is preferable to use a soft material in the plugging portion forming mask 30 so that the partition wall of the honeycomb structure 2 is not damaged when the partition wall comes into contact with the corner portion 39. A dimension of the corner portion 39 can be adjusted so that the plugging portion forming mask 30 slightly floats above the end surface of the honeycomb structure 2. In consequence, when cells 19a are filled with a plugging slurry 50, the plugging slurry 50 can slightly be projected from the end surface of the honeycomb structure 2, or the end surface of each partition wall can be covered with the plugging slurry 50. It is preferable to set a dimension of the convex portion 35 so that a ratio (h/b) between a height h of the portion and a bottom portion width b is 0.1 to 3.0, further preferably 0.5 to 2.0.

Moreover, as described above, an outer diameter of a maximum outer diameter portion (vicinity of a bottom portion of the convex portion) of the convex portion as a part of a plurality of convex portions 35 is set to be larger than an inner dimension of the cell 19b into which the convex portion fits. In consequence, the plugging portion forming mask 30 can more securely be fixed to the end surface of the honeycomb structure 2. The convex portion is constituted so that the outer diameter of the maximum outer diameter portion (the vicinity of the bottom portion of the convex portion) of the convex portion is larger than the inner dimension of the cell 19b into which the convex portion fits. It is preferable to arrange such convex portions in at least one position corresponding to the cell 19b at the center of the end surface of the honeycomb structure 2 and at least two positions at equal intervals, corresponding to the cells 19b in the vicinity of an outer periphery of the honeycomb structure 2. When a large number of convex portions having such a large diameter are present in the plugging portion forming mask 30, the plugging portion forming mask 30 is securely fixed to the end surface of the honeycomb structure 2. However, if an excessively large number of convex portions are arranged, the plugging portion forming mask 30 is not easily detached from the end surface of the honeycomb structure 2 when removed. Therefore, the number and arrangement of the convex portions need to appropriately be set in accordance with structures and dimensions of the cells of the honeycomb structure 2.

It is to be noted that, when the plugging portion forming mask 30 is fixed to the end surface of the honeycomb structure 2, to easily position the mask, it is preferable to arrange beforehand a protrusion or a groove as a reference for the positioning in an outer peripheral portion of the honeycomb structure 2 and the plugging portion forming mask 30. This is suitable especially for a case where the above positioning operation is automated. For example, a positional coordinate of the protrusion or the groove can be recognized using, for example, image processing or the like to control the positioning. According to the present invention, it is also preferable to cover the whole end surface of the honeycomb structure 2 with the integrally structured plugging portion forming mask 30. However, when the end surface of the honeycomb structure 2 has a large dimension in excess of a diameter of 250 mm, the plugging portion forming mask 30 may have a divided structure. In consequence, the fitting can be facilitated.

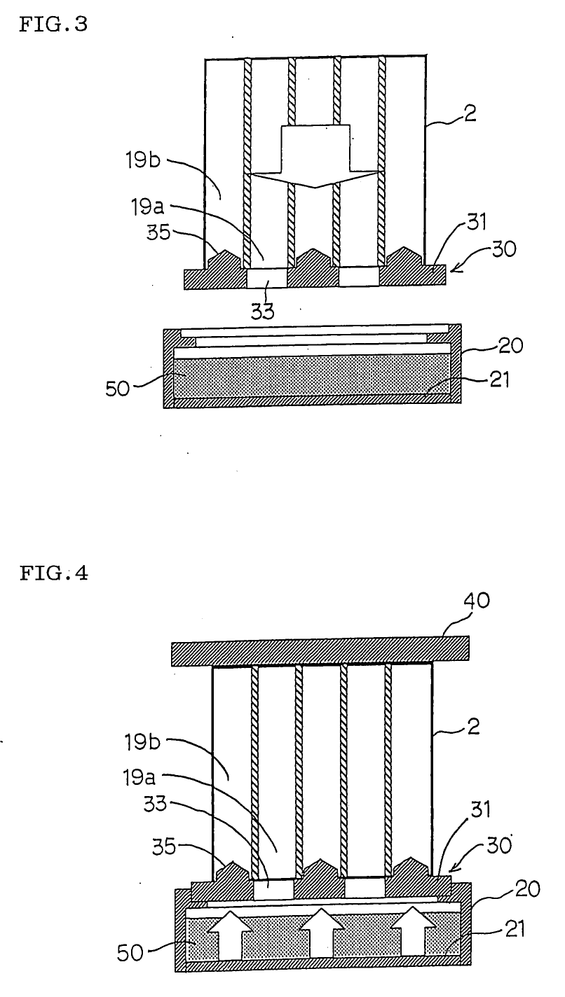

Subsequently, as shown in FIG. 3, a vessel 20 has, in an upper portion, an opening into which the plugging portion forming mask 30 can fit, and contains the plugging slurry 50 obtained by forming a material of the plugging portion into a slurry. The plugging portion forming mask 30 is fitted into the opening to thereby set, in the vessel, the honeycomb structure 2 to which the plugging portion forming mask 30 is fixed.

Subsequently, as shown in FIG. 4, the plugging slurry 50 stored in the vessel 20 is forced or sucked into opening ends of the cells 19a to be plugged through the pores 33 of the plugging portion forming mask 30 to thereby fill the opening ends of the cells.

In a case where the slurry is forced into the opening ends to fill the ends, for example, a bottom surface 21 of the vessel 20 is constituted so that the bottom surface can vertically be moved by a piston mechanism or the like. During the filling, the bottom surface 21 is moved upwards to set a volume of the vessel 20 to be smaller than that of the plugging slurry 50 stored in the vessel 20. In consequence, the plugging slurry 50 is pushed into the opening ends of the cells 19a from the vessel 20 to fill the ends. In a case where the slurry is sucked into the opening ends to fill the ends, the slurry is sucked with a pump or the like from an end surface of the honeycomb structure 2 opposite to the end surface fixed to the plugging portion forming mask 30. In consequence, the plugging slurry 50 stored in the vessel 20 is sucked up into the opening ends of the cells 19a to fill the ends. It is to be noted that to prevent leakage of the plugging slurry 50 during the filling, as shown in FIG. 4, it is preferable to lightly press plate-like pressing means 40 onto the end surface of the honeycomb structure 2 opposite to the end surface fixed to the plugging portion forming mask 30 so that the end surface of the honeycomb structure 2 comes into close contact with the upper surface of the plugging portion forming mask 30.

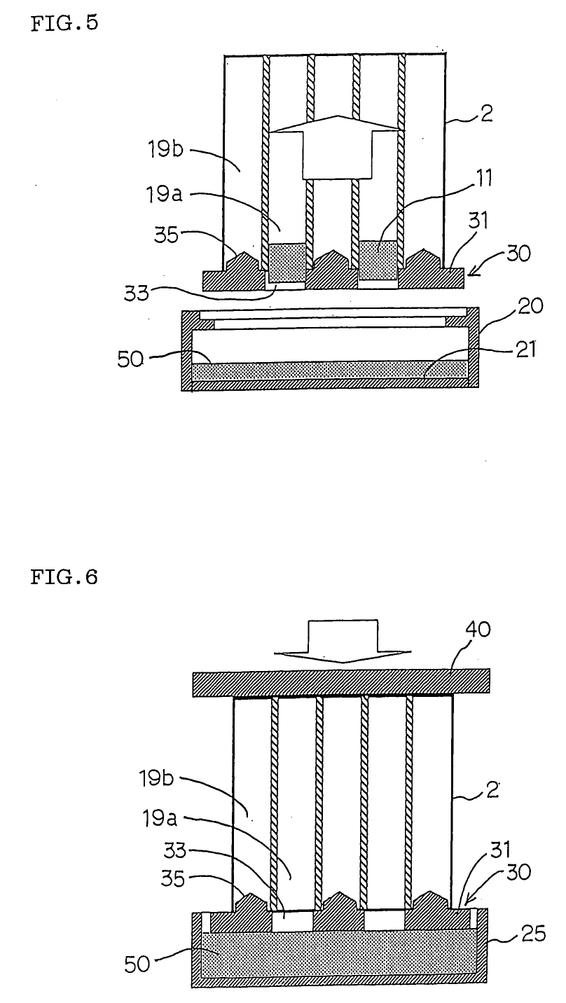

After the opening ends of the cells 19a to be plugged are filled with the plugging slurry 50 and plugging portions 11 are formed of the plugging slurry 50 as shown in FIG. 5, the plugging portion forming mask 30 is detached from the opening of the vessel 20. Subsequently, the plugging portion forming mask 30 is detached from the honeycomb structure 2. The other end surface of the honeycomb structure 2 is subjected to a similar plugging step. Furthermore, if necessary, the structure is dried and/or fired to obtain the plugged honeycomb structure.

It is to be noted that in the above example, after the plugging portion forming mask 30 is fixed to the end surface of the honeycomb structure 2, the plugging portion forming mask 30 is set in the vessel 20. However, after first setting the plugging portion forming mask 30 in the vessel 20, the end surface of the honeycomb structure 2 may be fixed to the plugging portion forming mask 30. That is, the plugging portion forming mask 30 is fitted into the opening of the vessel 20 to set the mask in the vessel having the opening into which the plugging portion forming mask 30 can fit and containing the plugging slurry 50 obtained by forming the material of the plugging portion into a slurry. Subsequently, the end surface of the honeycomb structure 2 is fixed to the plugging portion forming mask 30 so that the convex portions 35 of the plugging portion forming mask 30 fit into the cells 19b which are not to be plugged, and the opening ends of the cells 19a to be plugged are filled with the plugging slurry 50 stored in the vessel 20 through the pores 33 of the plugging portion forming mask 30 to thereby form the plugging portions 11.

Moreover, according to another embodiment of the manufacturing method of the present invention, as shown in FIG. 1, convex portions 35 of a plugging portion forming mask 30 are fitted into cells 19b which are not to be plugged to thereby fix the plugging portion forming mask 30 to an end surface of a honeycomb structure 2. Subsequently, as shown in FIG. 6, the end surface of the honeycomb structure 2 to which the plugging portion forming mask 30 is fixed is immersed into a plugging slurry 50 stored in a vessel 25, and opening ends of cells 19a to be plugged may be filled with the plugging slurry 50 through pores 33 of the plugging portion forming mask 30. It is to be noted that to fill the opening ends, as shown in FIG. 6, it is preferable to lightly press plate-like pressing means 40 onto an end surface of the honeycomb structure 2 opposite to the end surface fixed to the plugging portion forming mask 30 so that the plugging slurry 50 stored in the vessel 25 is securely forced into the opening ends of the cells 19a to be plugged.

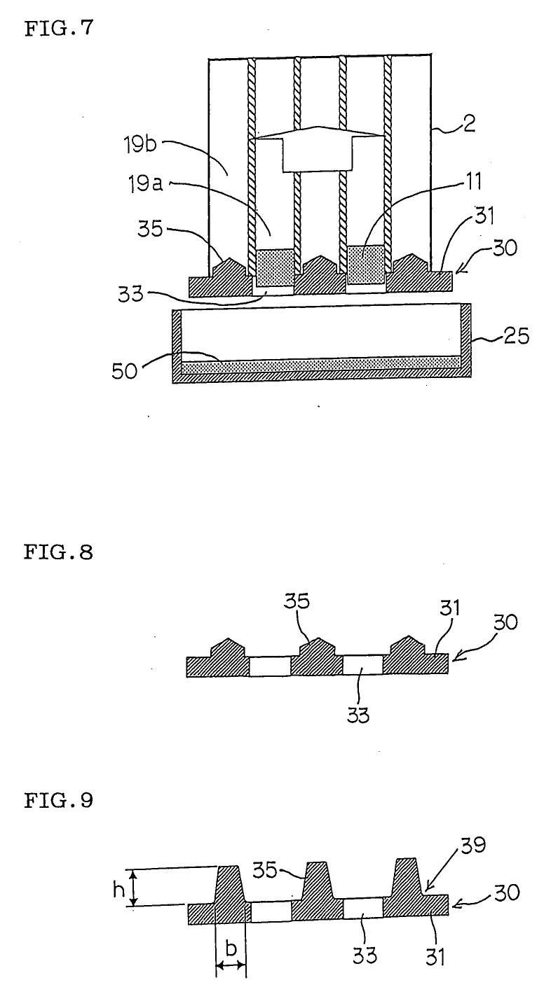

The opening ends of the cells 19a to be plugged are filled with the plugging slurry 50 in this manner. As shown in FIG. 7, plugging portions 11 are formed of the plugging slurry 50. Subsequently, the end surface of the honeycomb structure 2 to which the plugging portion forming mask 30 is fixed is pulled upwards from the vessel 25. Subsequently, the plugging portion forming mask 30 is detached from the honeycomb structure 2, the other end surface of the honeycomb structure 2 is subjected to a similar plugging step, and the structure is further dried and/or fired, if necessary, to obtain a plugged honeycomb structure.

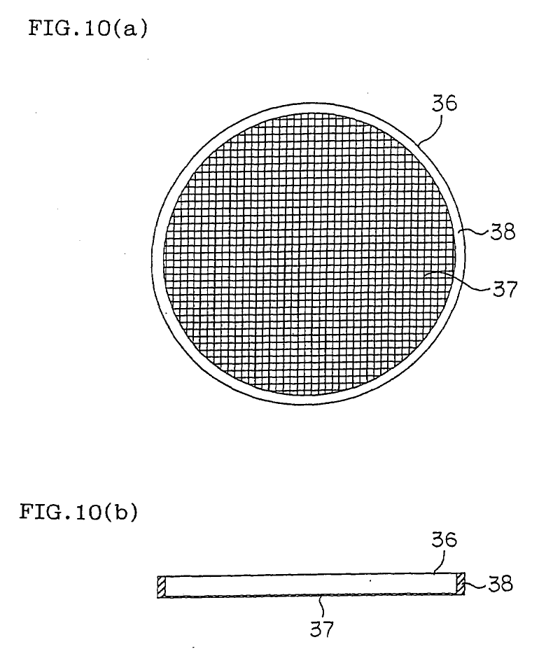

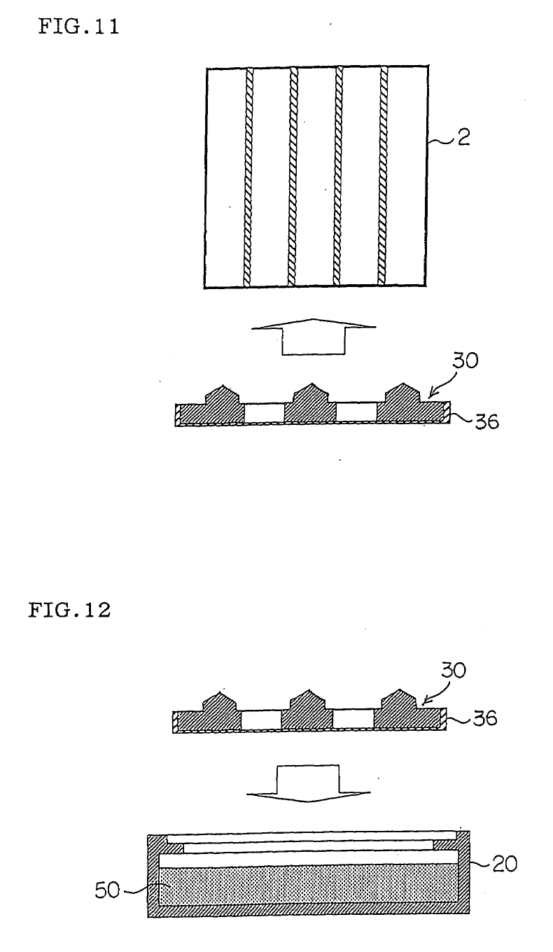

It is to be noted that the plugging portion forming mask 30 is made of a resin, and is so soft that the mask is easily deformed. Therefore, it is sometimes difficult to fix the mask to the end surface of the honeycomb structure 2 or set the mask in the opening of the vessel 20. In such a case, as shown in FIGS. 10(a) and 10(b), a mask support member 36 having a porous structure is prepared. The plugging portion forming mask 30 is fixed beforehand to the mask support member 36 having this porous structure so that the mask is not easily deformed. Subsequently, as shown in FIG. 11, it is preferable to fix the mask to the end surface of the honeycomb structure 2. Alternatively, as shown in FIG. 12, it is preferable to set the mask in the opening of the vessel 20. As the mask support member 36 having the porous structure, a member having a structure obtained by fixing an annular member 38 to a periphery of a wire mesh 37 is preferably usable. In this case, it is preferable that a linear diameter of the wire mesh 37 is reduced to increase porosity so that passage of the plugging slurry 50 is not hindered to the utmost.

In a honeycomb structure (a honeycomb structure before plugged) for use in the manufacturing method of the present invention, a plurality of cells which communicate between two end surfaces of the honeycomb structure are divided by porous partition walls. There is not any special restriction on a material constituting the honeycomb structure. Since the partition walls need to be porous, the honeycomb structure made of a ceramic (e.g., cordierite or the like) is usually preferably used. There is not any special restriction on a shape of the structure. For example, any shape such as a cylindrical shape, a square pole shape or a triangular prism shape may be used. It is most general to use the honeycomb structure having a quadrangular cell shape, but the structure may have another shape such as a polygonal shape, for example, a triangular shape, a hexagonal shape or an octagonal shape, a round shape or a shape obtained by combining these shapes.

Each partition wall of the honeycomb structure has a thickness of preferably 100 to 2000 μm, more preferably 200 to 1000 μm, further preferably 300 to 700 μm. If the thickness of the partition wall is less than 100 μm strength falls short, and a resistance to thermal shock drops in some case. On the other hand, if the thickness of the partition wall exceeds 2000 μm, a pressure loss tends to increase.

The honeycomb structure has a cell density of preferably 20 to 600 cells/in² (cpsi), more preferably 50 to 400 cpsi, further preferably 100 to 300 cpsi. If the cell density is less than 20 cpsi, a contact efficiency with an exhaust gas tends to fall short in a case where the structure is used in a carrier of a water flow type catalyst or the like. On the other hand, if the cell density exceeds 600 cpsi, the pressure loss tends to increase. It is to be noted that “cpsi” stands for “cells per square inch”, and is a unit indicating the number of the cells per square inch. For example, 10 cpsi is about 1.55 cells/cm².

The honeycomb structure has a porosity of preferably 30 to 90%, more preferably 45 to 80%, especially preferably 50 to 70%. When the porosity is set to 30 to 90%, the pressure loss can be reduced. Moreover, a heat capacity is reduced, and a mechanical strength of the structure can be held.

It is preferable that a mean pore diameter (a pore diameter) of the honeycomb structure is 5 to 500 μm. If the mean pore diameter is less than 5 μm, the pressure loss tends to increase. On the other hand, if the mean pore diameter exceeds 500 μm, a trap efficiency drops in a case where the structure is used in a filter. A contact area between the exhaust gas and a catalyst layer might not sufficiently be secured in a case where the structure is used in the carrier of the wall flow type catalyst or the like. If the pores enlarge, the structure is influenced to such an extent that a contact probability between a component of an exhaust gas passed through a pore and a catalyst layer of an inner surface of the pore decreases.

There is not any special restriction on the manufacturing method of such a honeycomb structure. However, the honeycomb structure can be manufactured by, for example, a method of extruding a ceramic clay having an appropriately adjusted viscosity by use of a die having desired cell shape, partition wall thickness and cell density (cell pitch), and drying an extruded body to obtain the honeycomb structure.

The slurry for plugging can be prepared by mixing, for example, ceramic powder and a dispersion medium (e.g., water or the like). Furthermore, if necessary, an additive such as a binder, a deflocculant or a foaming resin may be added. There is not any special restriction on a material of the ceramic powder, but it is preferable to use the same material as that of the honeycomb structure. As the binder, polyvinyl alcohol, methyl cellulose or the like is preferably usable.

According to the manufacturing method of the present invention, unlike the above conventional manufacturing method, the plugged honeycomb structure which does not have any defect can be manufactured simply with less steps without requiring many steps of attaching an adhesive sheet to the end surface of the honeycomb structure, image processing, making pores and peeling the adhesive sheet. Since the expensive adhesive sheet requiring an attaching operation in a clean environment is not necessary, production costs can be saved, there is not any restriction on the operating environment and industrial waste can be reduced.

The plugged honeycomb structure of the present invention is a plugged honeycomb structure including a honeycomb structure where a plurality of cells which communicate between two end surfaces of the honeycomb structure are divided by porous partition walls; and plugging portions arranged so as to plug one of two opening ends of each cell. The honeycomb structure is characterized in that cells to be plugged among cells positioned at an outermost periphery of the honeycomb structure are securely plugged with the plugging portions.

In a case where the plugged honeycomb structure including the plugging portions arranged in a checkered pattern at the end surface of the honeycomb structure is manufactured by a method described in Patent Document 2 (Japanese Patent Application Laid-Open No. 2002-159811) described above, that is, a method of attaching a non-dried formed sheet-like body including through holes in the checkered pattern under pressure to the end surface of a dried honeycomb-like body to integrally fire the body, as shown in FIG. 14, among the cells positioned at the outermost periphery of the honeycomb structure, the cells to be plugged (surrounded with dot lines in the drawing) are not plugged, or incompletely plugged cells are easily obtained. When such a plugged honeycomb structure is used as it is in, for example, a filter for filtering particulate substances to remove the substances, a disadvantage that a part of the particulate substances are discharged as they are without being filtered or the like is generated. Therefore, it is necessary to perform a treatment of attaching an annular member to the end surface of the honeycomb structure to cover openings of the cells positioned at the outermost periphery with the member or the like. In this case, since the cells positioned at the outermost periphery do not perform a function of the filter or the like, an effective area decreases.

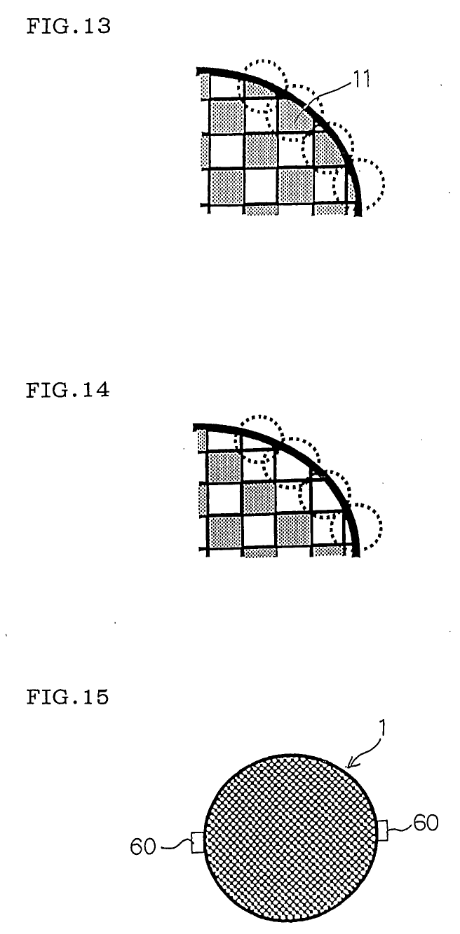

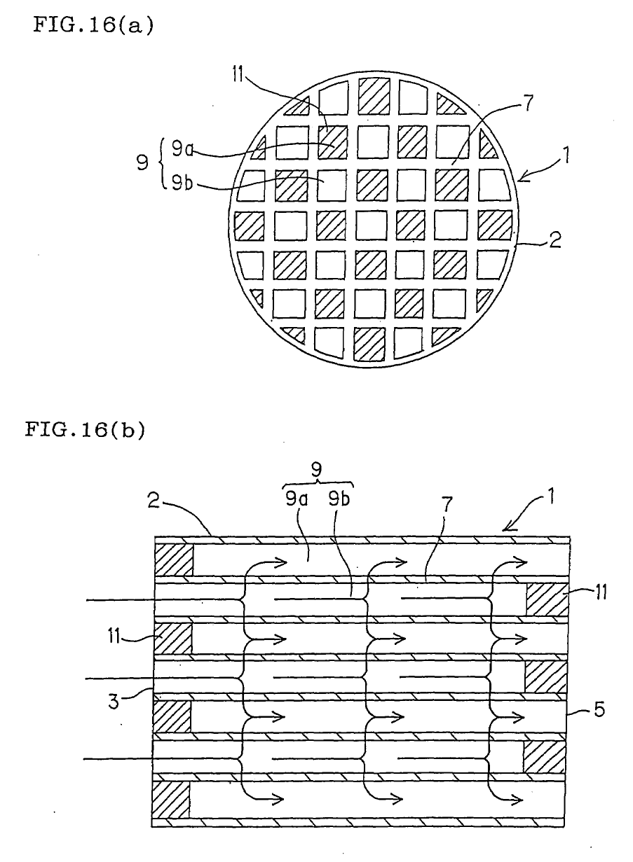

According to the plugged honeycomb structure of the present invention, as shown in FIG. 13, among the cells positioned at the outermost periphery of the honeycomb structure, the cells to be plugged (e.g., the cells surrounded with dot lines in the drawing, in a case where the plugged honeycomb structure including the plugging portions arranged so as to form the checkered pattern at the end surface of the honeycomb structure) are securely plugged with the plugging portions 11. Therefore, when the structure is used as a filter such as a diesel particulate filter for filtering the particulate substances or the carrier of the wall flow type catalyst, the above treatment is not necessary. Since there is not any decrease in the effective area due to the treatment, a high performance is exhibited.

Such a plugged honeycomb structure can be manufactured using the above manufacturing method of the present invention. It is to be noted that, when the structure is manufactured by the manufacturing method of the present invention, as shown in FIG. 15, the outer peripheral portion of the plugged honeycomb structure 1 may be provided with structural members such as protrusions 60 or grooves as references in positioning the mask for forming the plugging portions to fix the mask to the end surface of the honeycomb structure during the manufacturing. In only one end surface of the plugged honeycomb structure of the present invention, the cells may be plugged with the plugging portions.

### EXAMPLE

The present invention will hereinafter be described in more detail in accordance with examples, but the present invention is not limited to these examples.

Water, a binder and a surfactant were added to a cordierite forming material containing talc, kaolin and alumina as main materials, mixed and kneaded to obtain a forming material. The material was extruded into a columnar shape with a clay kneader, and formed with an extruder to obtain a formed body of a honeycomb structure (a formed honeycomb body). An end surface of the formed body obtained in this manner as the honeycomb structure was photographed with a CCD camera to acquire image data. The data was binarized to thereby specify shapes and positions of the cells to be plugged and the cells which were not to be plugged.

Furthermore, a central coordinate of the cells of the honeycomb structure and a cell density (a pitch between cells) were calculated from the same image data. Moreover, three-dimensional configuration data of a mask for forming plugging portions was prepared so that convex portions and pores were formed into appropriate shapes at correct positions with respect to the honeycomb structure. This three-dimensional configuration data was converted into CAD data, and slice data constituted of a large number of divided layers of a three-dimensional configuration of the mask for forming the plugging portions was prepared from the CAD data.

The surface of a non-set photo-setting component composition was irradiated with light in an imaging manner in accordance with this slice data to form a set resin layer having a tomographic configuration. Only one layer of non-set photo-setting component composition was additionally supplied to an upper surface of this set resin layer, and the surface was again irradiated with the light in the imaging manner. In consequence, the previously formed set resin layer and a new continuous set resin layer were formed and laminated. This operation was repeated a predetermined number of times to thereby prepare the plugging portion forming mask constituted of a photo-setting resin composition and having the pores capable of communicating with the cells to be plugged and the convex portions capable of fitting into the cells which were not to be plugged. In this case, as the irradiation light, an ultraviolet ray to be emitted from ultraviolet laser was used. As an optical forming device, SLA7000 (trade name: manufactured INCS INC.) was used.

The plugging portion forming mask prepared in this manner was fixed to one end surface of the honeycomb structure so that the convex portions fitted into the cells of the honeycomb structure which were not to be plugged. Next, the mask for forming the plugging portions was fitted into an opening of a vessel to set the honeycomb structure fixed to the mask for forming the plugging portions in the vessel having, in an upper portion, the opening into which the mask for forming the plugging portions fitted and containing a slurry for plugging obtained by forming a material of the plugging portion into a slurry. It is to be noted that a bottom surface of the vessel is vertically movable, and can be moved upwards so as to reduce a volume in the vessel. The bottom surface of this vessel was moved upwards to set the volume in the vessel to be smaller than a volume of the plugging portion forming mask stored in the vessel. In consequence, the slurry for plugging stored in the vessel was pushed into opening end portions of the cells to be plugged through the pores of the mask for forming the plugging portions to fill a depth of about 10 mm from the end surface of the honeycomb structure and form the plugging portions.

Subsequently, the mask for forming the plugging portions was removed from the end surface of the honeycomb structure. The other end surface of the honeycomb structure was also subjected to steps similar to the above steps. Subsequently, the plugging portions were dried, and the whole honeycomb structure was further fired to obtain a plugged honeycomb structure. At each end surface of the plugged honeycomb structure obtained in this manner, the cells to be plugged including the partial cells were all securely plugged with the plugging portions.

The present invention can preferably be used as a honeycomb structure for use in a filter such as the DPF for filtering the particulate substances, the carrier of the wall flow type catalyst or the like, and a manufacturing method of the honeycomb structure.

What is claimed is:

1. A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell,
the method comprising:
photographing the end surface of the honeycomb structure to acquire image data which specifies shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged;
fitting the convex portions into the cells which are not to be plugged to thereby fix the mask for forming the plugging portions to the end surface of the honeycomb structure;
then fitting the mask for forming the plugging portions into an opening of a vessel to thereby set the honeycomb structure to which the mask for forming the plugging portions is fixed in the vessel having, in an upper portion, the opening into which the mask for forming the plugging portions fits and containing a plugging slurry obtained by forming a material of the plugging portions into a slurry; and
filling opening ends of the cells to be plugged with the slurry for plugging contained in the vessel through the pores of the mask for forming the plugging portions to thereby form the plugging portions.

2. A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell,
the method comprising:
photographing the end surface of the honeycomb structure to acquire image data which specify shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged;
fitting the mask for forming the plugging portions into an opening of a vessel to thereby set the mask in the vessel having, in an upper portion, the opening into which the mask for forming the plugging portions fits and containing a plugging slurry obtained by forming a material of the plugging portions into a slurry;
then fixing the end surface of the honeycomb structure to the mask for forming the plugging portions so that the convex portions of the mask for forming the plugging portions fit into the cells which are not to be plugged; and
filling opening ends of the cells to be plugged with the slurry for plugging contained in the vessel through the pores of the mask for forming the plugging portions to thereby form the plugging portions.

3. A manufacturing method of a plugged honeycomb structure comprising: a honeycomb structure where a plurality of cells which communicate between two end surfaces of the honeycomb structure are divided by porous partition walls; and plugging portions arranged so as to plug one of two opening ends of each cell,
the method comprising:
photographing the end surface of the honeycomb structure to acquire image data which specifies shapes and positions of the cells to be plugged and the cells which are not to be plugged, preparing a mask for forming the plugging portions based on the image data by an optical forming process, the mask having pores which communicate with the cells to be plugged and convex portions which fit into the cells which are not to be plugged;
fitting the convex portions into the cells which are not to be plugged to thereby fix the mask for forming the plugging portions to the end surface of the honeycomb structure;
immersing the end surface of the honeycomb structure to which the mask for forming the plugging portions is fixed into a plugging slurry obtained by forming a material of the plugging portions into a slurry and contained in a vessel; and
filling opening ends of the cells to be plugged with the slurry for plugging through the pores of the mask for forming the plugging portions to thereby form the plugging portions.

4. The manufacturing method of the plugged honeycomb structure according to claim 1, wherein the mask for forming the plugging portions is fixed beforehand to a mask support member having a structure including a large number of pores, and then fixed to the end surface of the honeycomb structure.

5. The manufacturing method of the plugged honeycomb structure according to claim 2, wherein the mask for forming the plugging portions is fixed beforehand to a mask support member having a structure including a large number of pores, and then set in the vessel.

6. The manufacturing method of the plugged honeycomb structure according to claim 1, wherein the convex portions have a shape tapered toward a tip end.

7. The manufacturing method of the plugged honeycomb structure according to claim 6, wherein an outer diameter of a maximum outer diameter portion of the convex portion as a part of the convex portions is larger than an inner dimension of the cell into which the convex portion fits.

8. The manufacturing method of the plugged honeycomb structure according to claim 1, wherein among the convex portions, an outer diameter of the convex portion fitted into the cell positioned at an outermost periphery of the honeycomb structure and having a shape different from that of the cell disposed inwardly from the cell is smaller than that of the other convex portion.

9. A plugged honeycomb structure comprising: a honeycomb structure where a plurality of cells which communicate between two end surfaces of the honeycomb structure are divided by porous partition walls; and plugging portions arranged so as to plug one of two opening ends of each cell,
wherein the cells to be plugged among the cells positioned at an outermost periphery of the honeycomb structure are securely plugged with the plugging portions.

10. The plugged honeycomb structure, which is manufactured by the manufacturing method according to claim 1.

11. The plugged honeycomb structure according to claim 10, wherein an outer peripheral portion is provided with a protrusion or a groove as a reference of positioning during the fixing of the mask for forming the plugging portions to the end surface of the honeycomb structure.

12. The plugged honeycomb structure according to claim 9, wherein the cells are plugged with the plugging portions at only one end surface of the honeycomb structure.
